(19) United States
(12) Patent Application Publication
(10) Pub. No.: US 2025/0325443 A1
(43) Pub. Date: Oct. 23, 2025

(54) PROSTATE MASSAGE DEVICE

(71) Applicant: Jun Hyeong YUN, Gumi-si, Gyeongsangbuk-do (KR)

(72) Inventor: Jun Hyeong YUN, Gumi-si, Gyeongsangbuk-do (KR)

(21) Appl. No.: 18/868,157

(22) PCT Filed: May 18, 2023
(86) PCT No.: PCT/KR2023/006756

§ 371 Date: Nov. 21, 2024

(30) Foreign Application Priority Data
May 23, 2022 (KR) 10-2022-0062636

(51) Int. Cl. A61H 21/00; A61H 15/00

(52) U.S. Cl. CPC A61H 21/00; A61H 2015/0028; A61H 2201/1215; A61H 2201/149

(57) ABSTRACT

A prostate massage device (200) of the present invention includes: a base member (210); a first member (220) of a plate shape which is bent at a right angle to be spaced apart by a certain interval from the base member, includes a support plate (221) formed to be parallel to the base member; a second member (230) having one end portion rotatably coupled to the support plate (221); a third member (250) of a rod shape having one end portion rotatably coupled to the middle portion of the second member; an elastic spring (222) elastically supported between the base member and the support plate of the first member; a height adjusting means (280) which is configured to adjust an interval between the base member and the end of the support plate; and an upper plate cover (290) having a slit recess (291) formed therein.

### TECHNICAL FIELD

The present invention relates to a prostate massage device, and more particularly, to a massage device that improves massage efficiency to allow blood to smoothly flow between the anus and the genital organ of a human body, thereby preventing prostate disease in men and preventing urinary incontinence disease in women.

### BACKGROUND ART

The prostate and the urinary tract of the human body are located in the perineum that is located in the middle portion between the anus and the genital organ, and it is known that, when the perineum is massaged by applying appropriate vibration or pressure thereto, functional decrease or disease in the prostate and the urinary tract can be prevented.

An example of a general prostate massage device is described in Korean Patent Registration No. 10-1525585.

As illustrated in FIGS. 1 and 2, a prostate massage device 100 according to the related art includes a bottom frame 50 and a middle frame 60 on both sides thereof such that the prostate massage device 100 is supported on the floor of a room and is connected to an upper handle rod 70 by vertical shafts 40 and 41 such that the prostate massage device 100 is integrally formed.

A portion of a circular wheel 12 of a rotatable body 10 having a diameter ranging from 20 cm to 30 cm protrudes outward from a horizontal surface of a chair plate 30 between the middle frames 60, and the protruding wheel portion has a structure that may be rotated by a body weight.

Further, rails 61 are formed at upper ends of the middle frames 60 on both sides, and the chair plate 30 horizontally installed between the middle frame 60 and the upper handle rod 70 has a hole 31 formed in a middle portion thereof and having the form of a long axis hole having a diameter ranging from 15 cm to 30 cm. A wheel protruding portion of the rotatable body 10 supported on the middle frame 60 is formed in the hole 31 to protrude 1 cm to 3 cm upward from the horizontal surface of the chair plate 30. A structure in which rail holders 32 are fixed to bottom portions of both sides of the chair plate 30, and the rail holders 32 on both sides thereof surround the rails 61 formed at upper ends of the middle frames 60 is formed.

The structure is operated by a user sitting on the chair plate 30, holding the upper handle rod 70, and allowing the chair plate 30 to reciprocate in a front-rear direction, and thus the wheel protruding portion of the rotatable body 10 can press and massage the perineum between the anus and the genital organ of the human body.

Further, the middle frame 60 has the rail 61 formed at an upper central portion thereof and is configured such that the rail holder 32 of the chair plate 30 surrounds the rail 61 to prevent the rail 61 from escaping from the rail holder 32. Screw joints 33 in the form of concave grooves are formed in both sides of a bottom surface of the chair plate 30 so that the bottom rail holder 32 is fixed to the chair plate 30.

Meanwhile, the rotatable body 10 is connected to a fixing shaft 22 connected to a bottom fixing plate 23 and a U-shaped support 21 having an accommodating groove 21a accommodating the fixing shaft 22, to constitute a shock absorbing unit. A structure in which an elastic spring 24 is embedded in the fixing shaft 22 connected to the bottom fixing plate 23 and pressed by a lower end of the U-shaped support 21 is formed. An upper end 22a of the fixing shaft 22 is located inside the accommodating groove 21a formed at a central portion of the U-shaped support 21 in a cylindrical shape. Thus, a structure in which, when the user sits on the chair plate 30 and allows the chair plate 30 to reciprocate in a front-rear direction while pressing the protruding portion of the rotatable body 10, the rotatable body 10 is pushed by about 2 mm to about 10 mm downward and then returns to an original position thereof with elasticity is formed.

In the rotatable body 10, a circular wheel 12 may be made of a metal material having high thermal conductivity such as copper, and a hot water inlet 14 and a rubber cap 15 may be formed on one side of the circular wheel 12.

In the prostate massage device 100 according to the related art as described above, because the user should sit on the chair plate 30 by himself or herself and allow the chair plate 30 to reciprocate along the rail 61, use thereof is inconvenient. Further, because an elastic load of the rotatable body 10 that performs a massage action is achieved only by an action of the elastic spring 24, massage compression strength is constant regardless of the position of the chair plate 30, and thus a touch sense and efficiency of the massage are decreased.

### DESCRIPTION OF THE INVENTION

### Technical Problem

The present invention is created to solve the above problems, and is directed to providing a prostate massage device capable of implementing massage while varying compression strength with a simple structure.

The present invention is also directed to providing a prostate massage device that may have a small size, may be easily used, and in which a height of a massage contact part may be simply adjusted.

### Technical Solution

To achieve the purposes, a prostate massage device according to the present invention includes a base member, a plate-shaped first member, including a support plate bent at a right angle, spaced a predetermined distance from the base member, and parallel to the base member, installed upright on one side of the base member, a second member of which one end is rotatably coupled to the support plate and the other end is rotatably coupled to a massage roller, a rod-shaped third member of which one end is rotatably coupled to a middle portion of the second member and the other end is eccentrically coupled to a disc rotated by a driving motor, an elastic spring elastically supported between the base member and the support plate of the first member, a height adjusting means that adjusts a distance between the base member and a distal end of the support plate, and an upper plate cover having a slit groove configured such that a portion of an outer circumferential surface of the massage roller is exposed and moved.

Further, fixing parts of the base member and the first member may be rotatably coupled to each other.

### Advantageous Effects

A prostate massage device according to the present invention includes a base member, a plate-shaped first member including a support plate bent at a right angle, spaced a predetermined distance from the base member, and parallel to the base member and installed upright on one side of the base member, a second member of which one end is rotatably coupled to the support plate and the other end is rotatably coupled to a massage roller, a rod-shaped third member of which one end is rotatably coupled to a middle portion of the second member and the other end is eccentrically coupled to a disc rotated by a driving motor, an elastic spring elastically supported between the base member and the support plate of the first member, and a height adjusting means that adjusts a distance between the base member and a distal end of the support plate, so that a height of a massage contact part may be easily adjusted.

Further, a massage may be performed while varying a pressure intensity of a massage roller contact part when a massage roller moves, and manufacturing costs may be reduced due to a simple configuration of the device.

### DESCRIPTION OF DRAWINGS

FIG. 1 is a three-dimensional view of a prostate massage device according to the related art.

FIG. 2 is a cross-sectional view of a rotatable body of the prostate massage device according to the related art.

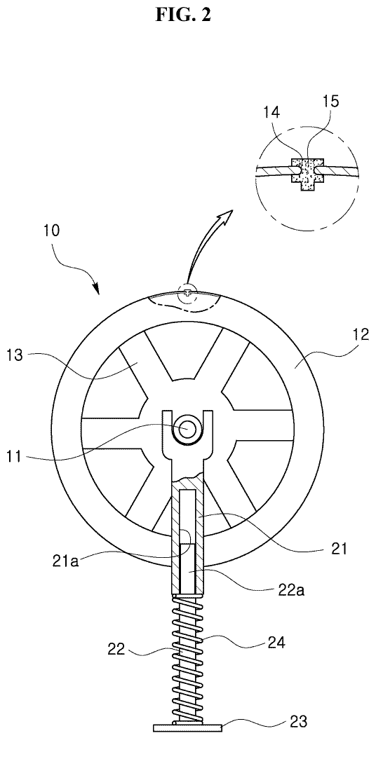

FIG. 3 is a three-dimensional view of a main part of a prostate massage device according to the present invention.

FIG. 4 is a plan view of the prostate massage device according to the present invention.

FIG. 5 is a front view of the prostate massage device according to the present invention.

FIG. 6 is a side view of the prostate massage device according to the present invention.

FIG. 7 is a view illustrating a state before a height adjusting means is driven according to the present invention.

FIG. 8 is a view illustrating a state after the height adjusting means is driven according to the present invention.

### BEST MODE

A prostate massage device 200 according to the present invention includes a base member 210, a plate-shaped first member 220 that includes a support plate 221 bent at a right angle, spaced a predetermined distance from the base member, and parallel to the base member and is installed upright on one side of the base member, a second member 230 of which one end is rotatably coupled to the support plate and the other end is rotatably coupled to a massage roller 240, a rod-shaped third member 250 of which one end is rotatably coupled to a middle portion of the second member and the other end is eccentrically coupled to a disc 270 rotated by a driving motor 260, an elastic spring 222 elastically supported between the base member and the support plate of the first member, a height adjusting means 280 configured to adjust a distance between the base member and a distal end of the support plate, and an upper plate cover 290 having a slit groove 291 configured such that a portion of an outer circumferential surface of the massage roller may be exposed and moved.

### Modes of the Invention

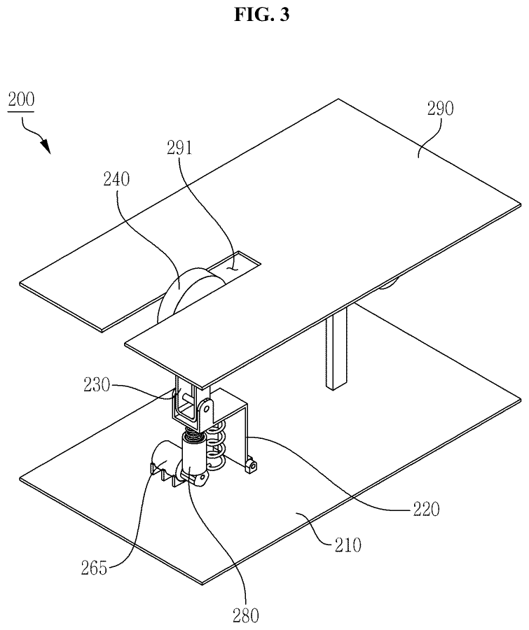

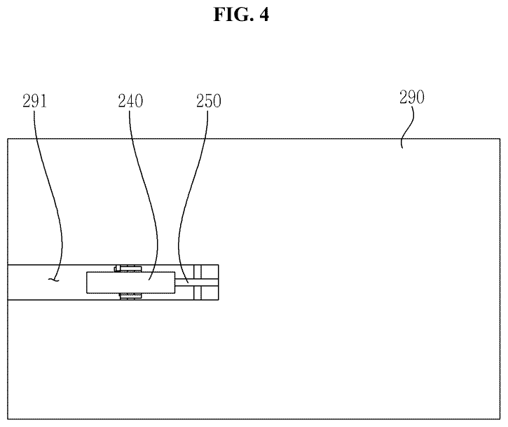

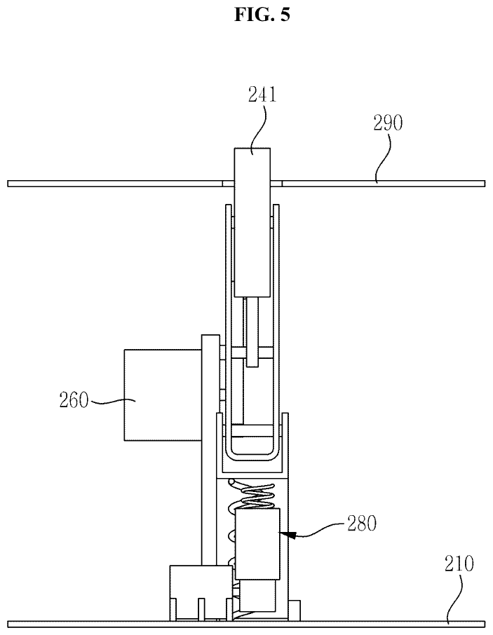

Hereinafter, a technical configuration and operational effects of a prostate massage device 200 according to the present invention will be described in detail with reference to FIGS. 3 to 8.

As illustrated in FIG. 3 to 6, the prostate massage device 200 according to the present invention includes a base member 210, a plate-shaped first member 220 installed upright on an upper surface of one side of the base member, a second member 230 of which one end is rotatably coupled to the first member and the other end is rotatably coupled to a massage roller 240, a rod-shaped third member 250 of which one end is rotatably coupled to a middle portion of the second member and the other end is eccentrically coupled to a disc 270 rotated by a driving motor 260, a height adjusting means 280 that adjusts a height of the second member 230, and an upper plate cover 290 having a slit groove 291 configured such that a portion of an outer circumferential surface of the massage roller 240 may be exposed and moved.

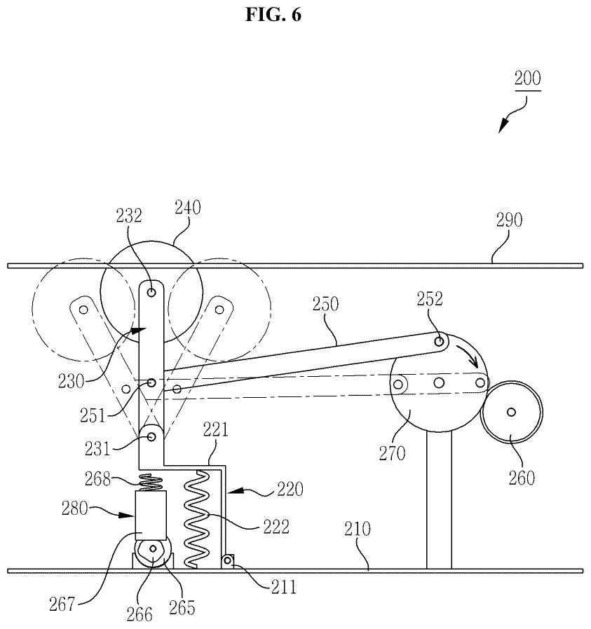

As illustrated in FIG. 6, the plate-shaped first member 220 includes a support plate 221 that is bent at a right angle, is spaced a predetermined distance from the base member 210, and is parallel to the base member, and is formed in a plate shape such that the first member 220 is installed upright on an upper surface of one side of the base member.

An elastic spring 222 is inserted between the base member 210 and the support plate 221 of the first member to reinforce an elastic force of the support plate when a load is applied from an upper side to a lower side of the support plate 221 of the first member. Fixing parts of the base member 210 and the first member 220 are configured to allow the first member to move with a fixing shaft 211 interposed therebetween.

Further, the second member 230 has one end rotatably coupled to a distal end of the support plate 221 of the first member with a fixing shaft 231 interposed therebetween and the other end rotatably coupled to a massage roller with a fixing shaft 232 interposed therebetween. The third member 250 has one end rotatably coupled to a middle portion of the second member 230 with a fixing shaft 251 interposed therebetween and the other end is eccentrically coupled to a disc 270 rotated by the driving motor 260 with a fixing shaft 252 interposed therebetween.

Meanwhile, the height adjusting means 280 may be configured to adjust a distance between the base member 210 and the distal end of the support plate 221.

The height adjusting means 280 may serve as a stopper when a load of a user's body is applied downward through the support plate 221, that is, the massage roller 240 and the second member 230, and at the same time, may adjust an exposure degree of the massage roller 240 by widening a gap between the base member 210 and the support plate 221 as needed and lifting the second member 230.

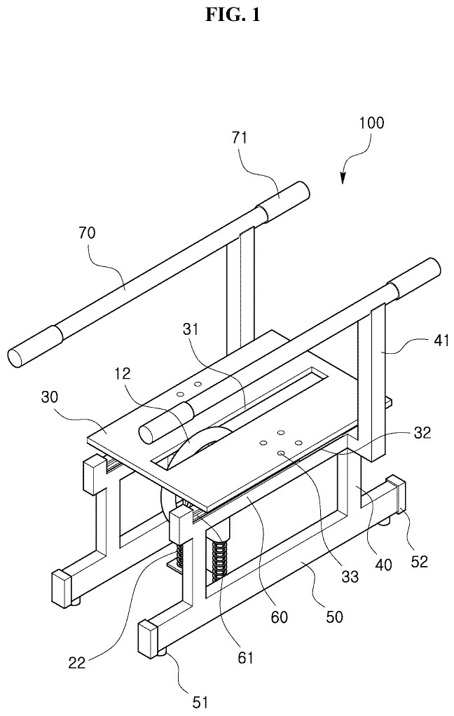

As illustrated in FIGS. 1 and 6, the height adjusting means 280 includes an eccentric cam 266 that rotates by driving a motor 265, and an operation pin 267 that is vertically elevated according to the rotation of the eccentric cam. A spring 268 is inserted into the operation pin 267 so that an end of the spring protrudes outward from the operation pin, and thus serves as a cushion when an upper end of the operation pin comes into contact with the support plate 221.

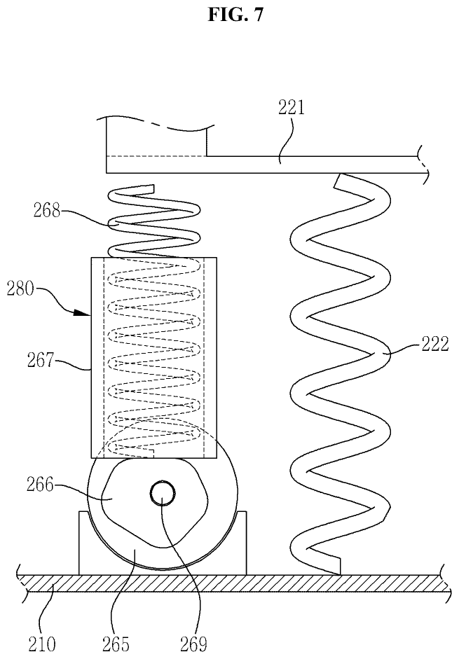

As illustrated in FIG. 7, the height adjusting means 280 controls a driving rotation angle of the motor so that a nearest portion of an outer circumferential surface of the eccentric cam 266 and a lower end of the operation pin 267 are in contact with each other with respect to a fixing shaft 269 of the motor in a state before driving, that is, in a state in which height adjustment is not required.

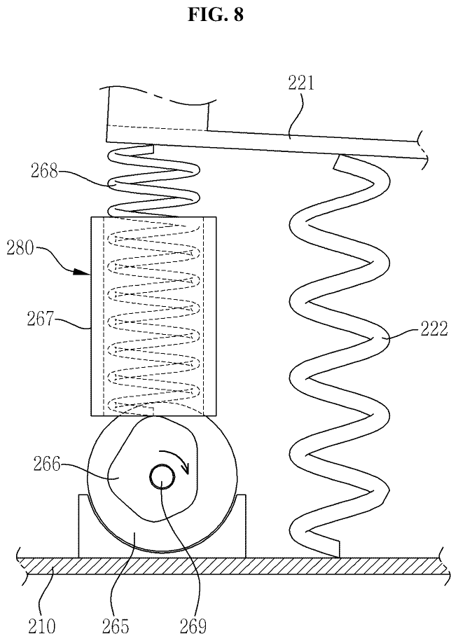

In contrast, as illustrated in FIG. 8, the height adjusting means 280 controls the driving rotation angle of the motor so that a farthest portion of an outer circumferential surface of the eccentric cam 266 and the lower end of the operation pin 267 are in contact with each other with respect to the fixing shaft 269 of the motor in a state in which the height adjusting means 280 is driven, that is, in a state in which height adjustment is required. Thus, it is preferable that the motor 265 of the height adjusting means use an encoder motor or the like capable of controlling forward rotation and reverse rotation and controlling a rotational angle of the fixing shaft.

Of course, when the eccentric cam 266 is continuously rotated, which cause the operation pin 267 to press the support plate 221 in a certain pattern and thus, the height adjusting means 280 according to the present invention may vibrate the massage roller 240.

As illustrated in FIG. 6, in the prostate massage device 200 according to the present invention, when the disc 270 rotates to pull the third member 250, the second member 230 is tilted to a right side with respect to the fixing shaft 231, and thus the massage roller 240 moves in an area of the slit groove 291. In contrast, when the disc 270 rotates to push the third member 250, the second member 230 is tilted to a left side with respect to the fixing shaft 231, and thus the massage roller 240 moves in the area of the slit groove 291.

Because a reciprocating movement path of the massage roller 240 has an arc shape, an exposure height of the roller at a central portion is high, and the exposure height of the roller becomes smaller as it goes toward opposite ends thereof. Thus, a pressure strength in contact with skin of the user of the prostate massage device 200 varies according to a position of the massage roller 240.

The prostate massage device 200 according to the present invention is not limited to the illustrated drawing structure and description, but may be variously modified and implemented within the scope of the appended claims and the purpose of the present invention.

### INDUSTRIAL APPLICABILITY

A massage device useful for preventing prostate disease in men and urinary incontinence disease in women is provided.

1. A prostate massage device comprising a base member, a plate-shaped first member including a support plate bent at a right angle, spaced a predetermined distance from the base member, and parallel to the base member installed upright on one side of the base member, a second member of which one end is rotatably coupled to the support plate and the other end is rotatably coupled to a massage roller, a rod-shaped third member of which one end is rotatably coupled to a middle portion of the second member and the other end is eccentrically coupled to a disc rotated by a driving motor, an elastic spring elastically supported between the base member and the support plate of the first member, a height adjusting means configured to adjust a distance between the base member and a distal end of the support plate, and an upper plate cover having a slit groove configured such that a portion of an outer circumferential surface of the massage roller is exposed and moved.

2. The prostate massage device of claim 1, wherein fixing parts of the base member and the first member are rotatably coupled to each other.
